(19) United States
(12) Patent Application Publication
(10) Pub. No.: US 2015/0371121 A1
(43) Pub. Date: Dec. 24, 2015

(54) IMAGE FORMING APPARATUS AND IMAGE PROCESSING METHOD

(71) Applicants: KABUSHIKI KAISHA TOSHIBA, Tokyo (JP); TOSHIBA TEC KABUSHIKI KAISHA, Tokyo (JP)

(72) Inventor: TAKAFUMI TERADA, Nagaizumi (JP)

(21) Appl. No.: 14/313,893

(22) Filed: Jun. 24, 2014

(51) Int. Cl. G06K 15/02

(52) U.S. Cl. CPC G06K 15/1872

(57) ABSTRACT

In image forming apparatus includes a binarization unit, a line thinning unit, and an output unit. The binarization unit binarizes each pixel of image data. The line thinning unit performs line thinning on pixels that are line thinning targets. The output unit outputs pixels that have been subjected to the line thinning by the line thinning unit.

### FIELD

Embodiments described herein relate generally to an linage forming apparatus and an image processing method.

### BACKGROUND

In general, in an electrophotographic-type printer, there is a tendency that linewidth of an image printed on a sheet prints out wider than the image represented in the underlying digital image. For this reason, in a print image in which reproduction of an accurate linewidth is required, there is a possibility that a defect may occur in the printed image. For example, when a barcode is printed but the individual lines are wider than intended, there is a possibility that the printed barcode may not be recognised by a barcode reader.

### DESCRIPTION OF THE DRAWINGS

FIG. 1 is a block diagram illustrating a configuration example of an image forming apparatus and an image forming system according to an embodiment.

FIG. 2 is a flowchart illustrating binarization processing in the image forming apparatus according to the embodiment.

FIG. 3 is a diagram illustrating an example of image data as a processing target of the image forming apparatus according to the embodiment.

FIG. 4 is a diagram illustrating an example of image data after being subject to the binarization processing in the image forming apparatus according to the embodiment.

FIG. 5 is a diagram illustrating an example of image data after being subject to line thinning processing in the image forming apparatus according to the embodiment.

FIG. 6 is a diagram illustrating an example of image data after being subject to halftone processing in the image forming apparatus according to the embodiment.

FIG. 7 is a flowchart illustrating a first processing example of selection processing in which an image to be output to a printer is selected in the image forming apparatus according to the embodiment.

FIG. 8 is a diagram illustrating an example of attribute information with respect to image data which is a processing target Of the image forming apparatus according to the embodiment.

FIG. 9 is a diagram illustrating an example of output image data in the image forming apparatus according to the embodiment.

FIG. 10 is a flowchart illustrating a second processing example of the selection processing in which an image to be output to the printer is selected in the image forming apparatus according to the embodiment.

FIG. 11 is a block diagram illustrating a configuration example when a color image is processed by the image forming apparatus according to the embodiment.

### DETAILED DESCRIPTION

In order to solve the above described problem, an image forming apparatus in which image forming processing for forming accurate linewidths may be executed, and an image processing method, are provided.

In general, according to one embodiment, there is provided an image forming apparatus including a binarization unit, a line thinning unit, and an output unit. The binarization unit binarizes each pixel of image data. The line thinning unit performs line thinning on pixels that are line thinning targets. The output unit outputs pixels that have been subjected to the line thinning by the line thinning unit.

Hereinafter, an embodiment will be described with reference to drawings.

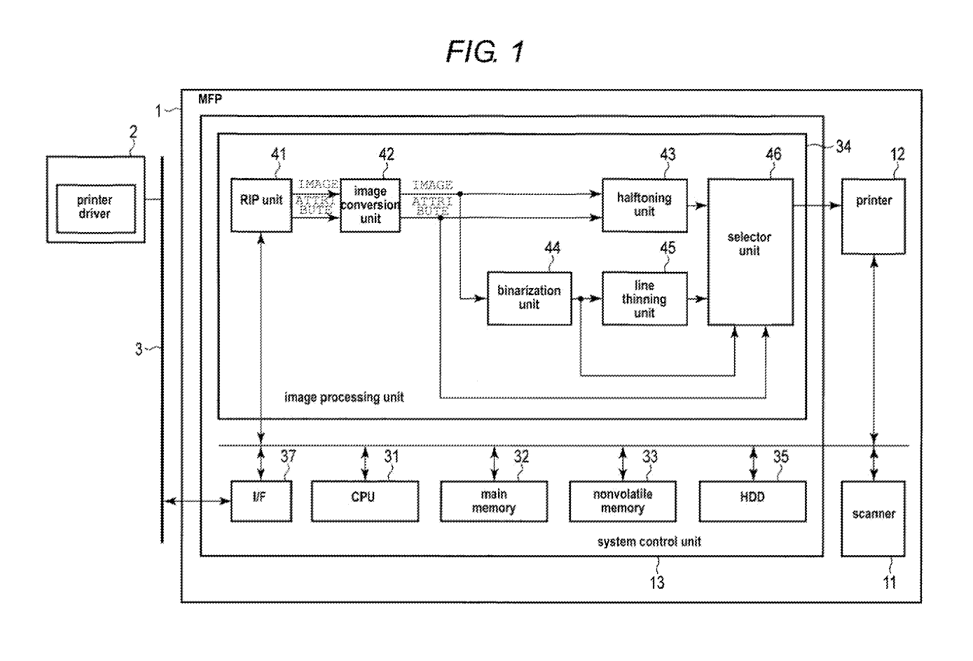

FIG. 1 is a block diagram illustrating the entire configuration of, and operational flow of, an image forming system including a digital Multi-Functional Peripheral (MFP) as an image forming apparatus according to the embodiment.

As illustrated in FIG. 1, the image forming system includes an MFP 1, a personal computer (PC) 2, and a network 3. The network 3 interconnects the MFP 1 and the personal computer 2. For example, the image forming system is a system in which the MFP 1 performs printing in response to a request (printing job) from the PC 2.

The MFP 1 is an electrophotographic-type image forming apparatus. The MFP 1 performs printing on a sheet in response to a printing request (printing job) from the PC 2. In addition, the MFP 1 also has a function of printing (copying function) an image on the original document which is read using a scanner onto a sheet, or the like. In addition, the MFP 1 has various printing modes. For example, the MFP 1 has a photographic mode, a character mode, a graphic mode, or the like, as the printing modes.

The PC 2 is a computer which executes processing when a processer executes a program stored in a memory. A printer driver which requests the MFP 1 to print an image is installed, in the PC 2. In the PC 2, when the processor executes a program of the printer driver, a request to print is made with respect to the MFP 1 in response to an instruction of a user.

First, a configuration of a digital multifunction peripheral (MFP) 1 will be described.

As illustrated in FIG. 1, the MFP 1 includes a scanner 11, a printer 12, and a system control unit 13.

The scanner 11 is a unit which optically reads an image on the original document, and converts the image into image data. The scanner 11 is controlled by the system, control unit 13. The scanner 11 outputs the image data on the original document to the system control unit 13. The scanner 11 is provided, for example, on the upper part of a main body of the MFP.

The printer 12 functions as an image forming unit. The printer 12 is controlled, by the system control unit 13. The printer 12 prints image data which is supplied from the system control unit 13 on a sheet which is the medium on which an image is formed. According to the embodiment, it is assumed that the printer 12 is an electrophotographic-type image forming apparatus.

The system control unit 13 includes a CPU (processor) 31, a main memory 32, a nonvolatile memory 33, an image processing unit 34, an HDD (hard disk drive) 35, and an interface (I/F) 37. The system control unit 13 is connected to the scanner 11 and the printer 12 through a system bus, or the like.

The CPU 31 controls the entire digital multifunction peripheral. The CPU 31 is a processor which executes processing by executing a program. The CPU 31 is connected to each unit in the apparatus through the system bus. The CPU 31 is also connected not only to each unit in the system control unit 13 but also to the scanner 11, the printer 12, or the like, through the system bus. The CPU 31 outputs an operation instruction to each unit, or acquires various items of information from each unit by performing a bidirectional communication with the scanner 11 and the printer 12.

The main memory 32 includes a RAM, or the like. The main memory 32 functions as a working memory, or a buffer memory. The nonvolatile memory 33 stores a program, control data, and the like. The nonvolatile memory 33 may be a non-rewritable and nonvolatile memory such as a ROM, or a rewritable nonvolatile memory such as an EEPROM. The CPU 31 executes various processes by executing a program which is stored in the nonvolatile memory 33, or in the HDD 35 and executed by the CPU 31 while using the main memory 32.

The hard disk drive (HDD) 35 is a large capacity storage unit. The HDD 35 stores image data, various items of history information such as previously printed or processed images, or the like. In addition, the HDD 35 may store a control program, control data, and the like. In addition, the HDD 35 may store setting information, processing conditions, and the like.

The interface 37 is an interface for communicating with the PC 2 through the network 3. The interface 37 receives a printing request (printing job) from the PC 2.

The image processing unit 34 converts an input image into an image for printing. In the configuration example illustrated in FIG. 1, the image processing unit 34 includes a RIP unit 41, an image conversion unit 42, a halftoning unit 43, a binarization unit 44, a line thinning unit 45, and a selector unit 46. Each of these unit functions in the image processing unit 34 may be achieved by executing a program which is stored by the processor for image processing in the memory for image processing, and may be achieved using one or a plurality of LSIs, or the like. In addition, each processing unit of the image processing unit 34 may be achieved when the processor 31 executes a program which is stored in the nonvolatile memory 33 using the main memory 32.

The RIP unit 41 develops image data in a raster format. The RIP unit 41 acquires image data which becomes a target of image forming and attribute information of the image data (information denoting any one of photographs, characters, and graphics in each pixel). The RIP unit 41 supplies the image data which is converted into the raster format, and the attribute information of the image data to the image conversion unit 42.

The image conversion unit 42 performs various conversions such as color conversion processing and filtering processing with respect to the image data. The image conversion unit 42 acquires the image data in the raster format and the attribute information from the RIP unit 41. The image conversion unit 42 performs image conversion processing with respect to the image data in the raster format. The image conversion unit 42 supplies the image data which is subject to image conversion to the halftoning unit 43 and the binarization unit 44. In addition, the image conversion unit 42 may supply the attribute information of the image data to the halftoning unit 43 and the selector unit 46.

The halftoning unit 43 performs halftoning with respect to image data. The halftoning unit 43 acquires image data of an image which is converted by the image conversion unit 42. The halftoning unit 43 performs halftoning with respect to the acquired image data. The halftoning unit 43 supplies the image data which is subject to halftoning to the selector unit 46.

The binarization unit 44 binarizes image data, i.e., it converts the image data into individual pixel data having a value of 1 or 0. The binarization unit 44 acquires converted image data from the image conversion unit 42. The binarization unit 44 binarizes the acquired image data. The binarization unit 44 supplies the binarized image data to a line thinning processing unit and a selector unit.

The line thinning unit 45 performs line thinning of an image based on a binarized image. The line thinning unit 45 acquires image data from the binarization unit 44. The line thinning unit 45 performs line thinning with respect to an image based on the acquired binarized image data. The line thinning unit 45 supplies the image data of an image subject to line thinning to the selector unit 46.

The selector unit 46 selects the image data, as between that output by the line thinning unit 45 and the halftoning unit 43, to be output for each pixel of the to be printed image. The selector unit 46 acquires attribute information from the image conversion unit 42, a halftone image from the halftoning unit 43, a binarized image from the binarization unit 44, and a line-thinned image from the line thinning unit 45. The selector unit 46 selects whether to output a halftone image from the halftoning unit 43 or to output a line-thinned image from the line thinning unit 45 for each pixel. For example, the selector unit 46 selects any one of a halftone image and a line-thinned image according to attribute information for each pixel. The selector unit 46 outputs each selected pixel to the printer 12 as image data for printing.

Subsequently, image processing in the image processing unit 34 of the MFP 1 according to the embodiment will be described.

First, binarization processing in the binarization unit 44 will be described.

When printing multi-value image data, the image processing unit 34 supplies image data which is processed by the RIP unit 41 and the image conversion unit 42 to the halftoning unit 43 and the binarization unit 44 as an input image.

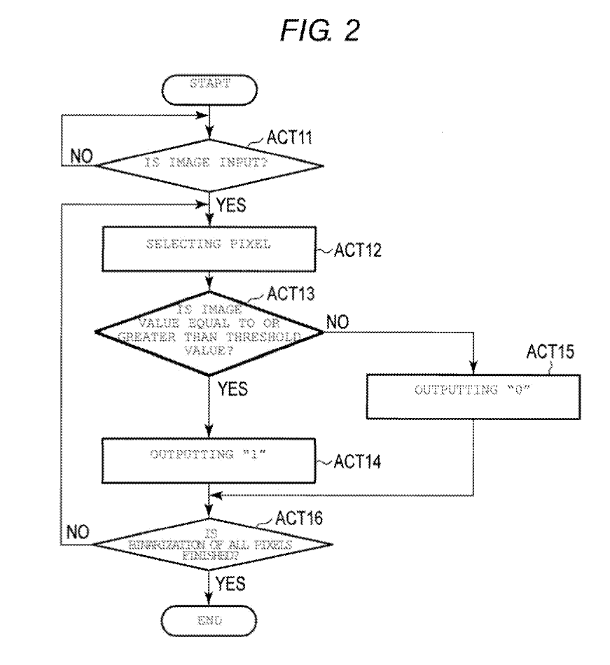

FIG. 2 is a flowchart illustrating binarization processing In the binarization unit 44.

When multi-value image data is input (Yes in ACT 11), the binarization unit 44 selects each pixel in the input image data sequentially (ACT 12). When a pixel is selected, the binarization unit 44 compares a pixel value of the selected pixel with a preset threshold value (threshold value of binarization) (ACT 13). When determining that the pixel value of the selected pixel is equal to or greater than the threshold value of binarization (Yes in ACT 13), the binarization unit 44 outputs “1” as a pixel value of the pixel (ACT 14).

In addition, when determining that the pixel value of the selected pixel is smaller than the threshold value of binarization (No in ACT 13), the binarization unit 44 outputs “0” as a pixel value of the pixel (ACT 15). When the pixel value in which the selected pixel is binarized is output, the binarization unit 44 determines whether or not binarization of all pixels in the input image is finished (ACT 16).

When determining that binarization of all pixels is not finished (ho in ACT 16), the binarization unit 44 selects the subsequent pixel, and executes processing from ACT 12 again. In addition, when determining that the binarization of all pixels is finished (Yes in ACT 16), the binarization unit 44 finishes binarization processing with respect to the input multi-value image.

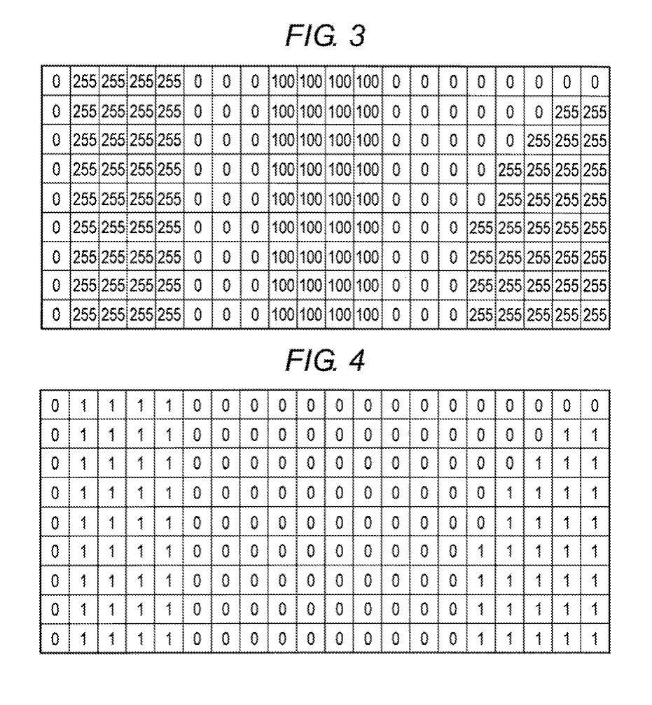

FIG. 3 is a diagram illustrating an example of an image which includes multi-value pixels which has pixel values of 0 to 255. FIG. 4 is a diagram, illustrating an example of a binarization image including pixels with binarized values in which the multi-value image including multi-value pixels illustrated in FIG. 3 is binarized.

The threshold value of binarization may be set to an arbitrary value. However, according to the embodiment, binarization processing is subject to line thinning processing. That is, according to the embodiment, the threshold value of binarization functions as a threshold value for extracting pixels from an image which are line thinning targets. For example, when a pixel with a maximum density vales (for example, “255”) is set to a processing target of the line thinning, the threshold value of binarization is set to the maximum density value. In addition, according to the embodiment, the threshold value of binarization is not limited to the maximum density value, and may be a value which may detect a pixel (region) which becomes a processing target of the line thinning which has a lesser density.

FIG. 4 is an example of a binarization image when the threshold value of binarization is set to “255” with respect to the image which is illustrated in FIG. 3. In this case, the binarization unit 44 converts a pixel value of each pixel of which a pixel value is less than the threshold value of binarization “255” (in example in FIG. 3, pixels of “0” and “100” except for “255”) in the multi-value image illustrated in FIG. 3 into “0”. In addition, the binarization unit 44 converts a pixel value of which at pixel value is equal to or greater than the threshold value of binarization “255” (in example in FIG. 3, pixels of “255”) in the multi-value image illustrated in FIG. 3 into “1”. As a result, the binarization unit 44 converts the multi-value image data illustrated in FIG. 3 into binary image data illustrated in FIG. 4.

Subsequently, line thinning processing in the line thinning unit 45 will be described.

The line thinning unit 45 performs thinning of linewidth of an image with respect to an output image of the binarization unit 44 (binarization image) as an input image. For example, the line thinning unit 45 performs processing in which a pixel value (density value) to be actually printed of an edge pixel in a pixel region in which a pixel value of a binarization image (binarized pixel value) becomes “1” is reduced (line thinning processing).

That is, the line thinning unit 45 detects a pixel region of which a pixel value is “1”. When detecting the pixel region of which the pixel value is “1”, the line thinning unit 45 specifies edge pixels in the pixel region of which the pixel value is “1”. When the edge pixels are specified, the line thinning unit 45 converts pixel values of pixels except for the edge pixels among the pixels of which the pixel value is “1” into the maximum density value (for example, “255”), and converts the pixel value of the edge pixels into a value which is smaller than the maximum density value (for example, “128”).

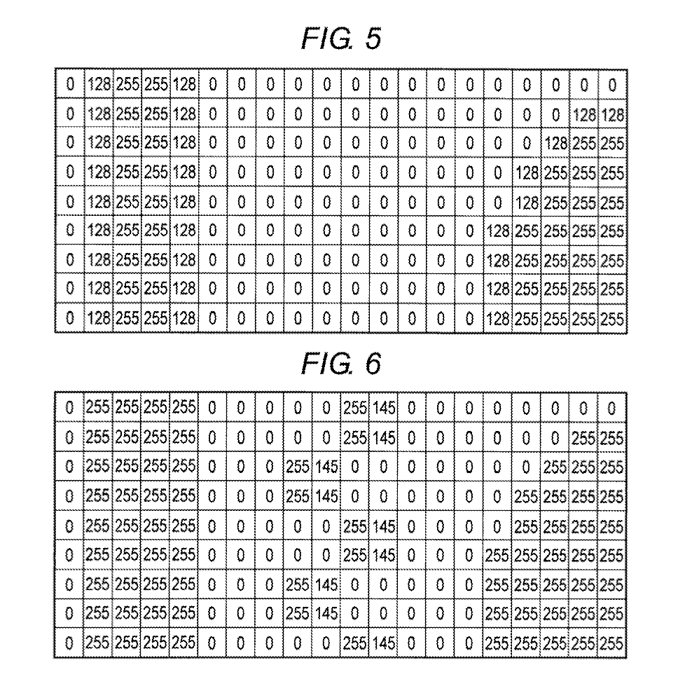

FIG. 5 is a diagram illustrating an example of a line-thinned image in which the binarization image illustrated in FIG. 4 is subject to line thinning.

In the example illustrated in FIG. 5, the line thinning unit 45 converts a pixel value of pixels except for the edge pixels among pixels of which a pixel value in the binarization image (binarized pixel value) is “1” into a density value of “255”, i.e., the maximum image density, and converts a pixel value of the edge pixels into “128”, i.e., about one-half of the maximum image density. That is, in the image illustrated in FIG. 5, pixels of which a pixel value is converted into “128” become an edge portion of a region which is actually printed. When the printer 12 prints the image illustrated in FIG. 5, since the edge portion of which the pixel value is set to “128” is printed lighter or less dense than the adjoining 255 regions, a region which is close to the edge portion is thinned, as a printing result thereof.

In addition, the halftoning unit 43 performs halftoning with respect to an image. The halftoning processing (halftone processing) is image conversion processing which is performed by the printer 12 in order to reproduce intermediate grayscale. The halftoning unit 43 extracts a region of intermediate grayscale which is changed to halftone from an input image. When the region of the intermediate grayscale is extracted, the halftoning unit 43 converts each pixel in the region of the intermediate grayscale according to a pattern structure of the halftone.

FIG. 6 is a diagram illustrating an example of a halftone image which is formed by performing halftone processing with respect to the multi-value image illustrated in FIG. 3.

The halftoning unit 43 extracts a pixel region of which a pixel value is “100” as a region of the intermediate grayscale in the multi-value image illustrated in FIG. 3. When an intermediate grayscale region which is formed of pixels of which a pixel value is “100” is extracted, the halftoning unit 43 converts the intermediate grayscale region into an array or assembly of pixel values as illustrated in FIG. 6 which may be easily reproduced according to a predetermined pattern structure by the printer 12. In addition, the halftoning unit 43 does not perform conversion with respect to pixels of which pixel values are “255” and “0”. As a result, the halftoning unit 43 converts the multi-value image illustrated in FIG. 3 into the halftone image illustrated in FIG. 6.

The selector unit 46 outputs any one of an image which is subject to halftoning (halftone image) and an image which is subject to line thinning processing (line-thinned image). For example, the selector unit 46 selects any of pixels of the halftone image and pixels of the line-thinned image based on a binarized output image (binarization image), an attribute, or the like, and outputs a value thereof for each pixel.

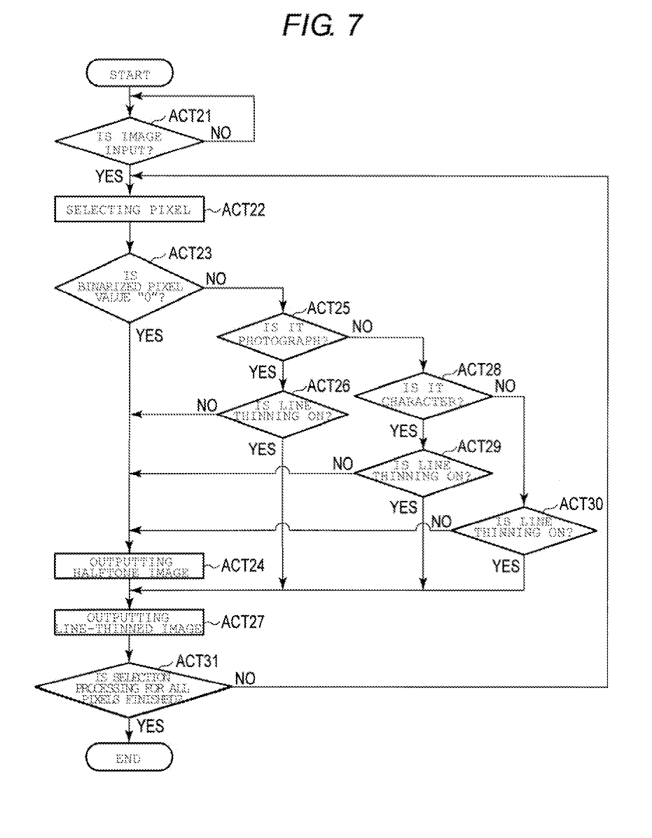

FIG. 7 is a flowchart illustrating a first processing example of processing performed by the selector unit 46 of FIG. 1. In addition, in the following descriptions, it is assumed that On-Off of the line thinning mode, i.e., whether line thinning is activated, is set in advance for each attribute (photograph, characters, or graphics).

The selector unit 46 inputs attribute information, a halftone image, a binary image, and a line-thinned image with respect to an image which is a processing target (ACT 21). When information related to the image which is the processing target is input, the selector unit 46 sequentially selects each pixel in the image (ACT 22). When a pixel, is selected, the selector unit 46 determines whether or not a binarized pixel value of a binarization image corresponding to the selected pixel is “0” (ACT 23). When the binarized pixel value is “0” (Yes in ACT 23), the selector unit 46 selects (outputs) the pixel of the halftone image as an output pixel of the pixel (ACT 24). It is possible to determine that the pixel of which the binarized pixel value is “0” is an image region in which line thinning is not necessary. For this reason, a pixel portion of which the binarized pixel value is “0” outputs a pixel which is subject to halftoning processing.

In addition, when it is determined that a pixel value of the binary image is not “0” (that is, “1”) (No in ACT 23), the selector unit 46 checks the attribute information of the pixel (ACT 25, ACT 28).

When it is determined that the attribute of the selected pixel is a photograph (Yes in ACT 25), the selector unit 46 determines whether or not a line thinning mode for a photograph is ON (ACT 26). When it is determined that the line thinning mode for the photograph is ON (Yes in ACT 26), the selector unit 46 selects (outputs) a pixel of the line-thinned image as an output pixel of the pixel (ACT 27). In addition, when it is determined that the line thinning mode for the photograph is OFF (No in ACT 26), the selector unit 46 selects (outputs) a pixel of the halftone image as an output pixel of the pixel (ACT 24).

When it is determined that an attribute of a selected pixel is characters (Yes in ACT 28), the selector unit 46 determines whether or not a line thinning mode for characters is ON (ACT 29). When it is determined that the line thinning mode for characters is ON (Yes in ACT 29), the selector unit 46 selects (outputs) a pixel of the line-thinned image as an output pixel of the pixel (ACT 27). In addition, when it is determined that the line thinning mode for characters is OFF (No in ACT 29), the selector tin it 46 selects (outputs) a pixel of a halftone image as an output pixel of the pixel (ACT 24).

When it is determined that an attribute of the selected pixel is graphics (No in ACT 28), the selector unit 46 determines whether or not the line thinning mode for graphics is ON (ACT 30). When it is determined that the line thinning mode for graphics is ON (Yes in ACT 30), the selector unit 46 selects (outputs) a pixel of the line-thinned image as an output pixel of the pixel (ACT 27). In addition, when it is determined that the line thinning mode for graphics is OFF (No in ACT 30), the selector unit 46 selects (outputs) a pixel of the halftone image as an output pixel of the pixel (ACT 24).

When the selected pixel, is output according to a selection result, the selector unit 46 determines whether or not the selection (output) processing of all pixels in the input image is finished (ACT 31). When it is determined that the selection processing of ail pixels is not finished (No in ACT 31), the selector unit 46 selects the subsequent pixel, and executes processing from ACT 22 again. In addition, when it is determined that the selection processing of all pixels is finished (Yes in ACT 31), the selector unit 46 finishes the processing of outputting the input multi-value image to the printer 12.

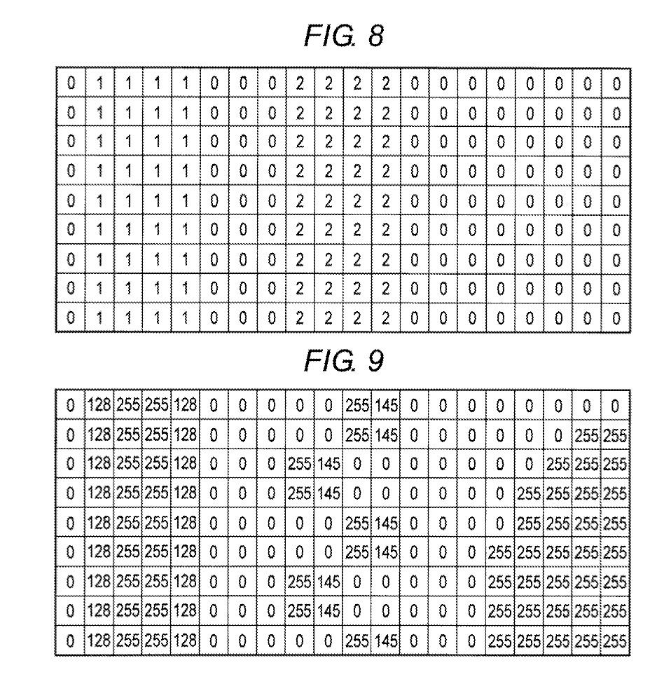

For example, FIG. 8 is a diagram illustrating an example of attribute information of an image with respect to each pixel of the image illustrated in FIG. 3. In addition, FIG. 9 is a diagram illustrating an example of an output image which is subject to selection processing based on the attribute information illustrated in FIG. 8. In FIG. 8, it is assumed that “0”, “1”, and “2” denote attribute information of a corresponding pixel. In the example illustrated in FIG. 8, it is assumed that a “0” denotes a photograph, a “1” denotes characters, and a “2” denotes graphics as attribute information.

When the binarization image illustrated in FIG. 4 is acquired, the selector unit 46 also checks the attribute of a pixel of which a pixel value is “1” in the binarization image illustrated in FIG. 4. According to the attribute information illustrated in FIG. 8, there are pixels in the to be printed image of which an attribute is characters (“1”), pixels of which an attribute is a photograph (“0”), among the pixels of which a pixel value is “1” in the binarization image illustrated in FIG. 4. When the line thinning mode for characters is ON, and the line thinning mode for photograph is OFF, as illustrated in FIG. 9, the selector unit 46 sets the pixel of which the attribute is characters to a pixel of a line thinned image, and sets the pixel of which the attribute is the photograph to a pixel of a halftone image, among the pixels of which the pixel value is “1” in the binarization image.

Subsequently, another example of the selection processing by the selector unit 46 will be described.

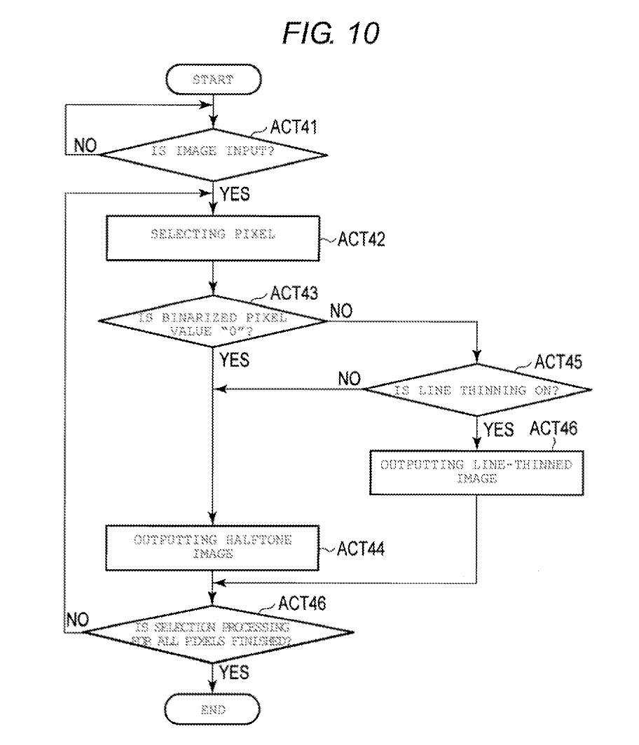

FIG. 10 is a flowchart illustrating a second processing example of the selection (output) processing by the selector unit 46.

The second processing example is a processing example in which whether or not line thinning processing is necessary is determined without checking the attribute of each pixel.

First, the selector unit 46 inputs a halftone image, a binary image, and a line-thinned image with respect to an image which is a processing target (ACT 41). When information relating to the image which is the processing target is input, the selector unit 46 sequentially selects each pixel in the image which is the processing target (ACT 42). When a pixel is selected, the selector unit 46 determines whether or not a binarized pixel value of the binarization image corresponding to the selected, pixel, is “0” (ACT 43). When the binarized pixel value is “0” (Yes in ACT 43), the selector unit 46 selects (outputs) a pixel of a halftone image as an output pixel of the pixel (ACT 44).

In addition, when it is determined that a pixel value of the binarization image is not “0” (that is, “1”) (No in ACT 43), the selector unit 46 determines whether or not the line thinning mode is ON (ACT 45). Here, in the line thinning mode, it is assumed that ON-OFF of the line thinning mode is set with respect to the image which is the processing target, not ON-OFF of the line thinning mode in regard to each attribute.

When it is determined that the line thinning mode is ON (Yes in ACT 45), the selector unit 46 selects (outputs) a pixel of the line thinning image as an output pixel of the pixel (ACT 46). In addition, when it is determined that the line thinning mode is OFF (No in ACT 45), the selector unit 46 selects (outputs) a pixel of the halftone image as an output pixel of the pixel (ACT 47).

When the selected pixel is output, the selector unit 46 determines whether or not the selection (output) processing of all pixels in the input image is finished (ACT 47). When it is determined that the selection processing of all pixels is not finished (No in ACT 47) t the selector unit 46 executes processing from ACT 42 again by selecting the subsequent pixel. In addition, when it is determined that the selection processing of all pixels is finished (Yes in ACT 47), the selector unit 46 finishes processing of outputting the input multi-value image to the printer 12.

In addition, in the second processing example, it is assumed that ON-OFF of line thinning mode is set with respect to the image, not with respect to each attribute. Accordingly, in the second processing example, when the line thinning mode is OFF, the selector unit 46 may output the halftone image as is without checking the binarized pixel value of each pixel. In addition, when the line thinning mode is OFF in the second processing example, the image processing unit 34 may omit the binarization processing and the line thinning processing.

In addition, ON-OFF of the line thinning mode may be directly set, or may be set according to the type of an image to be printed. The line thinning processing is applied to printing of an image of which the linewidth is to be reliably reproduced in barcode printing, or the like. For this reason, the setting of ON-OFF of the line thinning mode may be switched according to a type of an image which is a printing target. For example, when barcode printing is selected by a user, the processor 31 may set the line thinning mode to ON.

In addition, whether or not the line thinning mode is ON may be determined by determining whether or not the to foe printed image is one which should be subjected to line thinning (for example, whether or not it is barcode), in the determination in ACT 45 in FIG. 10. That is, when it is determined that the image which is the printing target is an image to be subjected to line thinning processing (determined to be barcode printing), the selector unit 46 may determine that the line thinning mode is required and set the line thinning mode to ON.

In addition, the above described processing may be applied to a color image.

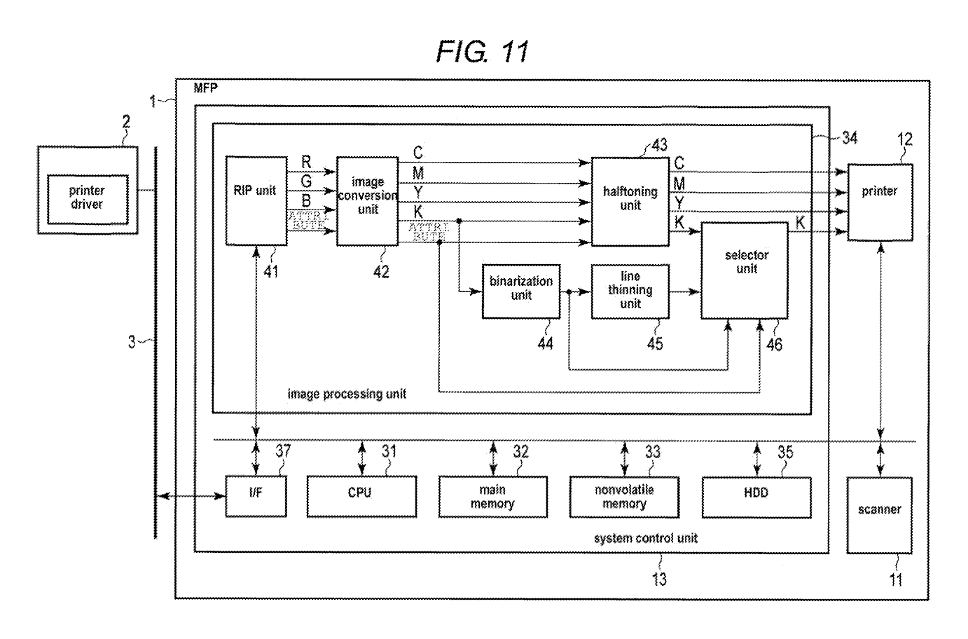

FIG. 11 is a block diagram illustrating a configuration example when the image processing unit 34 of the MFP 1 has a color image as a printing target.

When a color image is set to a printing target, the color image which is formed of each pixel signal of RGB, and attribute information are input to the image processing unit 34. The RIP unit 41 performs RIP processing with respect to each signal of RGB. The image conversion unit 42 converts each signal of R, G, and B into each color signal of C, M, Y, and K. That is, when an input image is a color image, an output image of the image conversion unit 42 becomes image signals of C, M, Y, and K of four colors.

However, in many cases, a color signal which needs line thinning is only a black (K color) color in the barcode printing, or the like. For this reason, in the configuration example illustrated in FIG. 11, the above-described line thinning processing is performed with respect to the K color. That is, in the configuration example illustrated in FIG. 11, the image conversion unit 42 supplies only the K signal in the output image to the binarization unit 44. In this manner, in the image processing unit 34 illustrated in FIG. 11, when the input image is a color image, it is possible to configure such that the binarization processing using the binarization unit 44, the line thinning processing using the line thinning unit 45, and the selection processing using the selector unit 46 are performed with respect only to the K color.

As described above, the MFP according to the embodiment performs the binarization processing with respect to the multi-value input image, and performs the line thinning processing with respect to the image after the binarization processing. In addition, the MFP selects any one of the image after the line thinning processing and an image which is formed by performing half tone processing with respect to an input image based on a pixel value after the binarization processing, and outputs thereof.

In this manner, even in printing of a multi-value image, i.e., one with different types of images such as text, bar codes and photographs, pixels which need line thinning are extracted, and thus line thinning processing is performed with respect to an image region which needs line thinning. As a result, even in printing of the multi-value image, for example, it is possible to print an image of which digital linewidth such as a barcode which is needed to foe reliably reproduced on a sheet, by performing line thinning processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forme or modifications as would fall within the scope and spirit of the inventions.

What is claimed is:

1. An image forming apparatus comprising:
a binarization unit configured to binarize each pixel of image data;
a line thinning unit configured to perform line thinning on pixels that are line thinning targets; and
an output unit configured to output pixels that have been subjected to the line thinning by the line thinning unit.

2. The apparatus according to claim 1,
wherein the line thinning unit is configured to perform line thinning on an edge pixel in a region of pixels having pixel values of normal print density, the edge pixel having a pixel value of a lower print density than the normal print density after the line thinning is performed thereon.

3. The apparatus according to claim 2,
wherein the output unit is further configured to select for output, the edge pixel that have been subjected to the line thinning based on a line thinning attribute of the edge pixel.

4. The apparatus according to claim 1,
wherein each pixel has a multi-value pixel value.

5. The apparatus according to claim 1,
wherein the image data represents an image of a barcode.

6. The apparatus according to claim 1,
wherein the image data is color image data including color pixels, each of which produces a different color signal,
wherein the binarization unit is configured to binarize a specific color signal, and
wherein the line thinning unit is configured to perform line thinning on color pixels that are line thinning targets with respect to the specific color signal.

7. An image forming apparatus comprising:
an image acquiring unit configured to acquire image data;
a binarization unit configured to binarize each pixel of the image data acquired by the image acquiring unit;
a line thinning unit configured to perform line thinning on pixels that are line thinning targets;
an output unit configured to output pixels that have been subjected to the line thinning by the line thinning unit; and
an image forming unit configured form an image on a medium based on the pixels output from the output unit.

8. The apparatus according to claim 7,
wherein the line thinning unit is configured to perform line thinning on an edge pixel in a region of pixels having pixel values of normal print density, the edge pixel having a pixel value of a lower print density than the normal print density after the line thinning is performed thereon.

9. The apparatus according to claim 8,
wherein the output unit is further configured to select for output the edge pixel that have been subjected to the line thinning based on a line thinning attribute of the edge pixel.

10. The apparatus according to claim 7,
wherein each pixel has a multi-value pixel value.

11. The apparatus according to claim 7,
wherein the image data represents an image of a barcode.

12. The apparatus according to claim 7,
wherein the image data is color image data including color pixels, each of which produces a different color signal,
wherein the binarization unit is configured to binarize a specific color signal, and
wherein the line thinning unit is configured to perform line thinning on color pixels that are line thinning targets with respect to the specific color signal.

13. An image processing method comprising:
binarizing each pixel of image data;
performing line thinning on pixels that are line thinning targets; and
outputting pixels that have been subjected to the line thinning.

14. The method according to claim 13,
wherein the line thinning is performed on an edge pixel in a region of pixels having pixel values of normal print density, the edge pixel having a pixel value of a lower print density than the normal print density after the line thinning is performed thereon.

15. The method according to claim 14, further comprising:
selecting for output the edge pixel that have been subjected to the line thinning based on a line thinning attribute of the edge pixel.

16. The method, according to claim 13,
wherein each pixel has a multi-value pixel value.

17. The method according to claim 13,
wherein the image data represents an image of a barcode.

18. The method according to claim 13,
wherein the image data is color image data including color pixels, each of which produces a different color signal;
wherein a specific color signal is binarized; and
wherein the line thinning is performed on color pixels that are line thinning targets with respect to the specific color signal.
